(19) United States
(12) Patent Application Publication
(10) Pub. No.: US 2026/0368200 A1
(43) Pub. Date: Nov. 19, 2026

(54) GENERATING DATA VISUALIZATIONS FOR FUNCTIONAL SPECIFICATIONS

(71) Applicant: International Business Machines Corporation, Armonk, NY (US)

(72) Inventors: Pengyuan Li, San Jose, CA (US); Guangjie Ren, Belmont, CA (US); Robert John Moore, San Jose, CA (US); Chung-hao Tan, San Jose, CA (US); Alice Yoonjeong Lee, Cupertino, CA (US)

(21) Appl. No.: 19/206,129

(22) Filed: May 13, 2025

(51) Int. Cl. G06F 16/26; G06F 16/22

(52) U.S. Cl. CPC G06F 16/26; G06F 16/2246

(57) ABSTRACT

Computer-implemented methods for generating data visualizations for functional specifications are disclosed herein. Aspects include generating a hierarchical structure using requirements extracted from a functional specification file received from a user device. Aspects further include generating an enriched node corresponding to a node of the hierarchical structure using the functional specification file and contextual data.

Aspects also include replacing the node of the hierarchical structure with the enriched node. Aspects further include generating a diagram for the enriched node using a text-to-diagram learning model. Aspects also include generating a data visualization of the functional specification file comprising the diagram for the enriched node of the hierarchical structure.

### BACKGROUND

The present invention generally relates to database analysis, and more specifically, to computer systems, computer-implemented methods, and computer program products for generating data visualizations for functional specifications.

A functional specification file, which can be referred to as a functional specification, is frequently used for processes, such as bidding and procurement, to delineate the objectives, scope, and specific needs of a project. In many instances, functional specification files include a broad range of information, including project overviews, detailed requirement statements, and intricate dependencies among various elements. By way of example, such files may span hundreds of pages, thereby posing significant challenges for users who are tasked with extracting pertinent details efficiently. Accordingly, the manual review and interpretation of such files may not fully capture the significant relationships and priorities embedded within the requirements.

Current approaches for understanding complex functional requirement specifications often rely on static visual representations or manually produced diagrams. However, these methods can be labor-intensive and prone to oversight. Further complicating the analysis is the differences in format and content that characterizes these documents. Such variations make the identification of significant interrelationships among requirements difficult.

### SUMMARY

Embodiments of the present invention are directed to a computer-implemented method for generating data visualizations for functional specifications. According to an aspect of the invention, a computer-implemented method includes generating a hierarchical structure using requirements extracted from a functional specification file received from a user device. In some embodiments, each node of the hierarchical structure corresponds to a requirement extracted from the functional specification file. The method also includes generating an enriched node corresponding to a node of the hierarchical structure using the functional specification file and contextual data. The method further includes replacing the node of the hierarchical structure with the enriched node. The method also includes generating a diagram for the enriched node using a text-to-diagram learning model. The method further includes generating a data visualization of the functional specification file that includes the diagram for the enriched node of the hierarchical structure.

In one embodiment of the present invention, generating the enriched node using the functional specification file and the contextual data further includes analyzing the node of the hierarchical structure based on a position of the node in the hierarchical structure, a classification of the requirement of the node, and a data taxonomy associated with the hierarchical structure. The method also includes collecting the contextual data by obtaining data associated with the requirement of the node. The method further includes generating the enriched node by augmenting the node with the contextual data.

In one embodiment of the present invention, the contextual data is extracted from a related functional specification file, a related hierarchical structure, or a knowledge bank.

In one embodiment of the present invention, the method includes building a dataset comprising associations between images, textual descriptions, and type of diagram using generative adversarial networks, wherein the images and text descriptions are obtained from a data source. The method also includes training the text-to-diagram learning model using the dataset and a deep learning model.

In one embodiment of the present invention, generating the diagram for the enriched node using the text-to-diagram learning model further includes determining whether the diagram for the enriched node exists. In response to determining that the diagram for the enriched node does exist, the method includes updating the diagram using the enriched node and associating the diagram with the enriched node.

In one embodiment of the present invention, generating the diagram for the enriched node using the text-to-diagram learning model further includes determining whether the diagram for the enriched node exists. In response to determining that the diagram for the enriched node does not exist, the method includes generating a new diagram using the text-to-diagram learning model. The method also includes associating the enriched node with the new diagram.

In one embodiment of the present invention, the method includes identifying the requirements of the functional specification file using file parsing, file structure analysis, textual content extraction, and semantic analysis. The method further includes extracting the requirements from the functional specification file.

According to another non-limiting embodiment of the invention, a system having a memory having computer readable instructions and one or more processors for executing the computer readable instructions, the computer readable instructions controlling the one or more processors to perform operations. The operations include generating a hierarchical structure using requirements extracted from a functional specification file received from a user device. In some embodiments, each node of the hierarchical structure corresponds to a requirement extracted from the functional specification file. The operations also include generating an enriched node corresponding to a node of the hierarchical structure using the functional specification file and contextual data. The operations further include replacing the node of the hierarchical structure with the enriched node. The operations also include generating a diagram for the enriched node using a text-to-diagram learning model. The operations further include generating a data visualization of the functional specification file that includes the diagram for the enriched node of the hierarchical structure.

According to another non-limiting embodiment of the invention, a computer program product for a large language model privacy preservation system is provided. The computer program product includes a computer-readable storage medium having program instructions embodied therewith, the program instructions executable by a processor to cause the processor to perform operations. The operations include generating a hierarchical structure using requirements extracted from a functional specification file received from a user device. In some embodiments, each node of the hierarchical structure corresponds to a requirement extracted from the functional specification file. The operations also include generating an enriched node corresponding to a node of the hierarchical structure using the functional specification file and contextual data. The operations further include replacing the node of the hierarchical structure with the enriched node. The operations also include generating a diagram for the enriched node using a text-to-diagram learning model. The operations further include generating a data visualization of the functional specification file that includes the diagram for the enriched node of the hierarchical structure.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts a block diagram of an example computer system for use in conjunction with one or more embodiments of the present invention;

FIG. 2 is a data flow diagram depicting the flow of data in a system that includes a functional specification visualization system in accordance with one or more embodiments of the present invention;

FIG. 3 is a block diagram of a system for a functional specification visualization system in accordance with one or more embodiments of the present invention;

FIG. 4 is a data flow diagram depicting a detailed workflow for generating a data visualization corresponding to a functional specification file in accordance with one or more embodiments of the present invention;

FIG. 5 is a flowchart of a method for extracting requirements from a functional specification file for generating a data visualization in accordance with one or more embodiments of the present invention; and

FIG. 6 is a flowchart of a method for generating data visualizations for functional specifications in accordance with one or more embodiments of the present invention.

### DETAILED DESCRIPTION

Disclosed herein are methods, systems, and computer program products for a functional specification visualization system. As discussed above, functional specification files can be lengthy, dense, and difficult to understand. In many instances, the density and length of the functional specification files make identifying conflicts in requirements difficult.

The systems and methods described herein are directed to a functional specification visualization system that automatically generates data visualizations from extracted requirements of a functional specification file. The functional specification visualization system can build a dataset of associations between images and the text of requirements of functional specification files. In some embodiments, the functional specification visualization system collects images and corresponding text descriptions from different sources. Using one or more artificial intelligence techniques or models, such as generative adversarial networks, the functional specification visualization system generates mappings between images and their corresponding text descriptions and associates diagrams types with the mappings. For example, a list of steps identified in the text may be best illustrated as a flow chart so the diagram type associated with the mapping of the list of steps may be designated as a flow chart. Using the curated dataset of images, text descriptions, and diagram types, the functional specification visualization system trains a text-to-diagram learning model. The text-to-diagram learning model converts text identified from a functional specification file into a diagram.

The systems and methods described herein are directed to receiving functional specification files from user devices. The functional specification visualization system receives the functional specification files and processes. In some embodiments, the functional specification visualization system identifies and extracts requirements from the functional specification files and generates a hierarchical structure, such as a tree structure. Each node of the hierarchical structure corresponds to an extracted requirement. The functional specification visualization system constructs the hierarchical structure based on the relationships and associations identified during the processing of the functional specification file.

The functional specification visualization system enriches the nodes of the hierarchical structure using context information obtained from the functional specification file, previously submitted functional specification files, related files, a knowledge bank, or other identified data sources. The requirements in the nodes can be enriched with additional information such as definitions, examples, identification of related requirements, and the like.

In some embodiments, the functional specification visualization system traverses through the hierarchical structure of enriched nodes to generate corresponding diagrams. The functional specification visualization system uses the text-to-diagram learning model trained using the curated dataset to generate a diagram that correspond to each enriched node of the hierarchical structure. The functional specification visualization system then constructs a data visualization that includes all of the generated diagrams. The data visualization can be an interactive graphic that enables the user to view additional information about a requirement, edit data in the functional specification file, and the like.

Various aspects of the present disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

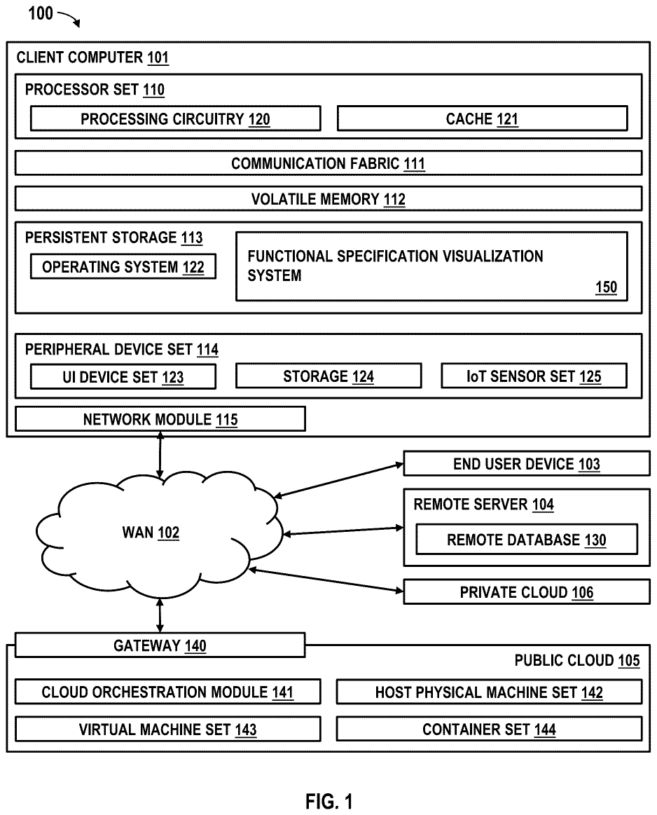

Referring now to FIG. 1, computing environment 100 contains an example of an environment for the execution of at least some of the computer code involved in performing the inventive methods, such as extracting requirements from a functional specification file, generating a hierarchical structure, enriching nodes of the hierarchical structure, and generating a data visualization corresponding to the functional specification file by a functional specification visualization system 150. In addition to the functional specification visualization system 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and the functional specification visualization system 150, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Client computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in the functional specification visualization system 150 in persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface type operating systems that employ a kernel. The code included in the functional specification visualization system 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collects and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

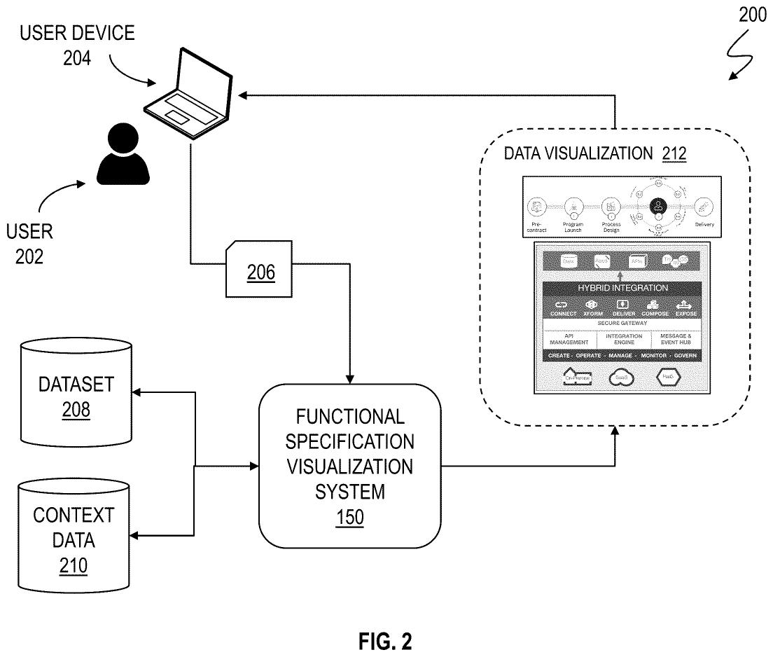

Referring now to FIG. 2, a data flow diagram depicting the flow of data in system 200 that includes a functional specification visualization system 150 in accordance with one or more embodiments of the present invention. A user 202 interacts with a user device 204, such as a desktop computer, laptop computer, cell phone, tablet, or the like, to create and edit a functional specification file 206. In some embodiments, the functional specification file 206 contains requirements for an objective for a project and can include a background section, scope, objective, requirements, timelines, and the like. The functional specification file 206 can be a lengthy file that describes a project, the project purpose, different types of requirements (e.g., non-functional requirements, technical requirements, etc.), projected timeline, evaluation criteria, and the like. Examples of a functional specification file 206 can include but is not limited to a requirements document, a request for information file, a request for proposal file, functional requirements file, system requirements specification, technical specification file, product requirements file, and the like.

The user device 204 transmits the functional specification file 206 to the functional specification visualization system 150. The functional specification visualization system 150 processes and analyzes the functional specification file 206 using one or more artificial intelligence techniques and a text-to-diagram learning model trained and maintained by the functional specification visualization system 150. The functional specification visualization system 150 processes the functional specification file 206 to generate a hierarchical structure, such as a tree structure, which contains nodes for each requirement extracted from the functional specification file 206. The functional specification visualization system 150 enriches the nodes of the hierarchical structure using contextual data, such as from the context datastore 210, and applies the text-to-diagram learning model that utilizes a dataset 208 curated by the functional specification visualization system 150 on the hierarchical structure to generate a data visualization 212 corresponding to the functional specification file 206.

The context datastore 210 is a collection of data obtained from different sources, such as previously received functional specification files 206, source files identified in functional specification files 206, the Internet, a knowledge bank, a user device 204, and the like. The dataset 208 is a compilation of data that includes associations between diagrams, corresponding textual descriptions, and types of diagrams or diagram types. Examples of types of diagrams include, but are not limited to, flow charts, Gantt charts, timelines, block diagrams, Venn diagrams, total quality management diagrams, mind maps, road maps, and the like.

The data visualization 212 generated by the functional specification visualization system 150 is a graphic representation of the functional specification file 206 that includes diagrams corresponding to requirements extracted from the functional specification file 206. In some embodiments, the data visualization 212 is an interactive graphic that enables the user 202 to view additional information about a requirement, edit data in the functional specification file 206, and the like. The functional specification visualization system 150 then transmits the data visualization 212 available to the user device 204 or otherwise makes the data visualization 212 available to the user device 204.

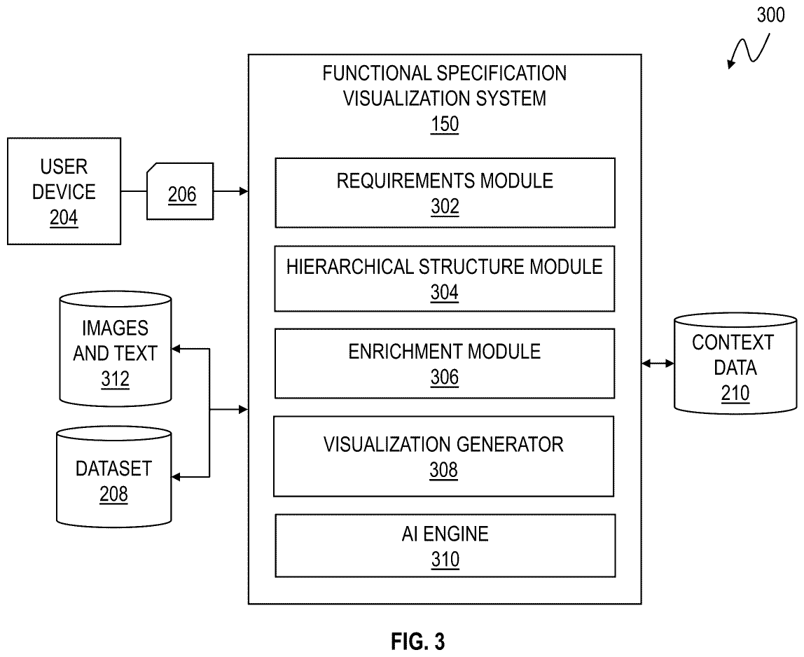

Referring now to FIG. 3, a system 300 for a functional specification visualization system 150 in accordance with one or more embodiments of the present invention is shown. In exemplary embodiments, the system 300 includes a functional specification visualization system 150 that may be embodied in a computer 101, such as the one shown in FIG. 1. As illustrated, the system 300 includes one or more user devices 204 that can generate and manage functional specification files 206. In some embodiments, a user device 204 transmits the functional specification file 206 to functional specification visualization system 150. In some embodiments, the user device 204 transmits the functional specification file 206 directly to the functional specification visualization system 150.

The functional specification visualization system 150 is configured to receive or otherwise obtain the functional specification file 206 from the user device 204. The functional specification visualization system 150 includes a requirements module 302, a hierarchical structure module 304, an enrichment module 306, a visualization generator 308, and an artificial intelligence (AI) engine 310. The functional specification visualization system 150 interacts with one or more datastores, such as the images and text datastore 312, the dataset 208, and or the context datastore 210.

The requirements module 302 receives the functional specification file 206 and processes and analyzes the content of it. In some embodiments, the requirements module 302 instructs the AI engine 310 to parse the content of the functional specification file 206.

The AI engine 310 maintains and manages AI models and techniques. Examples of AI models can include but are not limited to machine learning models, neural networks, deep learning models, and the like. The AI engine 310 directs engines or classifiers to execute machine learning algorithms, which can collect and analyze data and execute tasks without explicit instructions. Examples of engines/classifiers include but are not limited to neural networks, support vector machines (SVMs), logistic regression, decision trees, hidden Markov Models (HMMs), etc. The machine learning algorithms apply machine learning techniques to the received data in order to, over time, create/train/update a unique “model.” The learning or training performed by the engines/classifiers can be supervised, unsupervised, or a hybrid that includes aspects of supervised and unsupervised learning. Supervised learning is when training data is already available and classified/labeled. Unsupervised learning is when training data is not classified/labeled so must be developed through iterations of the classifier. Unsupervised learning can utilize additional learning/training methods including, for example, clustering, neural networks, deep learning, k-nearest neighbors, Bayesian methods, and the like.

In one or more embodiments, the engines/classifiers managed by the AI engine 310 are implemented as neural networks (or artificial neural networks), which use a connection (synapse) between a pre-neuron and a post-neuron, thus representing the connection weight. Neuromorphic systems are interconnected elements that act as simulated “neurons” and exchange “messages” between each other. Similar to the so-called “plasticity” of synaptic neurotransmitter connections that carry messages between biological neurons, the connections in neuromorphic systems such as neural networks carry electronic messages between simulated neurons, which are provided with numeric weights that correspond to the strength or weakness of a given connection. The weights can be adjusted and tuned based on experience, making neuromorphic systems adaptive to inputs and capable of learning. After being weighted and transformed by a function (i.e., transfer function) determined by the network's designer, the activations of these input neurons are then passed to other downstream neurons, which are often referred to as “hidden” neurons. This process is repeated until an output neuron is activated. Thus, the activated output neuron determines (or “learns”) and provides an output or inference regarding the input.

In some embodiments, the AI engine 310 directs one or more AI techniques or models to parse the content of the functional specification file 206, which includes analyzing and interpreting the structure of the content of the functional specification file 206. In some embodiments, the AI model or technique examines the syntax and grammar of the text to identify patterns and relationships between elements, divides the content into smaller units, and the like.

In some embodiments, the AI engine 310 vectorizes and indexes the functional specification file 206 using any known techniques to vectorize and index the functional specification file 206. In some embodiments, the AI engine 310 extracts images or diagrams and context information associated with the image (e.g., captions, references in text, etc.) from the functional specification file 206, generates a text summary of the image and context information, and vectorizes and indexes the text summary. In some embodiments, the AI engine 310 segments the content of the functional specification file 206 before vectorizing and indexing it to generate processed content.

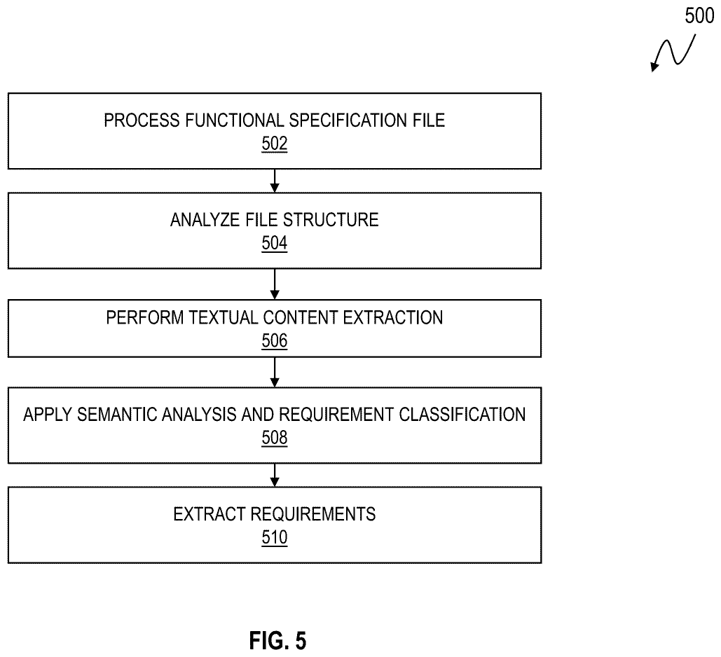

In some embodiments, the requirements module 302 instructs the AI engine 310 to perform structure analysis, semantic and requirements classification, and textual content extraction on the processed content of the functional specification file 206 to extract requirements from the functional specification file 206 and generate metadata associated with the extracted requirements, as further discussed in FIG. 5.

The hierarchical structure module 304 obtains the extracted requirements and associated metadata from the requirements module 302. In some embodiments, the metadata associated with the extracted requirements include, but are not limited to, identified associations and relationships between requirements, classifications of the requirements, and the like. The hierarchical structure module 304 generates a hierarchical structure, such as a tree structure, using the extracted requirements and associated metadata. For example, the hierarchical structure module 304 uses the textual content extracted from the functional specification file 206 to generate nodes for each extracted requirement and then constructs the tree based on the relationship and association information of the metadata.

The enrichment module 306 receives or obtains the hierarchical structure from the hierarchical structure module 304. In some embodiments, the enrichment module 306 traverses through the hierarchical structure and communicates with the AI engine 310 to enrich each node. The AI engine 310 identifies keywords of the textual content of a node and uses one or more AI techniques or models to obtain contextual information related to the keywords. In some embodiments, the AI engine 310 obtains the contextual information from the functional specification file 206 and/or a datastore, such as the context datastore 210. The context datastore 210 is a set of data obtained from different sources, such as previously received functional specification files 206, source files identified in functional specification files 206, the Internet, a knowledge bank, and the like. In some embodiments, the enrichment module 306 updates and manages the context datastore 210 using data from the functional specification file 206, such as definitions, examples, links to external data sources, information obtained from a user 202, and the like.

The enrichment module 306 uses the context information and the node of the hierarchical structure to generate an enriched node. In some embodiments, the enrichment module 306 augments or modifies the node of the hierarchical structure using the context information to generate the enriched node. In some embodiments, the enrichment module 306 generates the enriched node by creating a new node using information from the node of the hierarchical structure and the context information. The enrichment module 306 replaces the node of the hierarchical structure with the enriched node and deletes the node that was previously in the hierarchical structure.

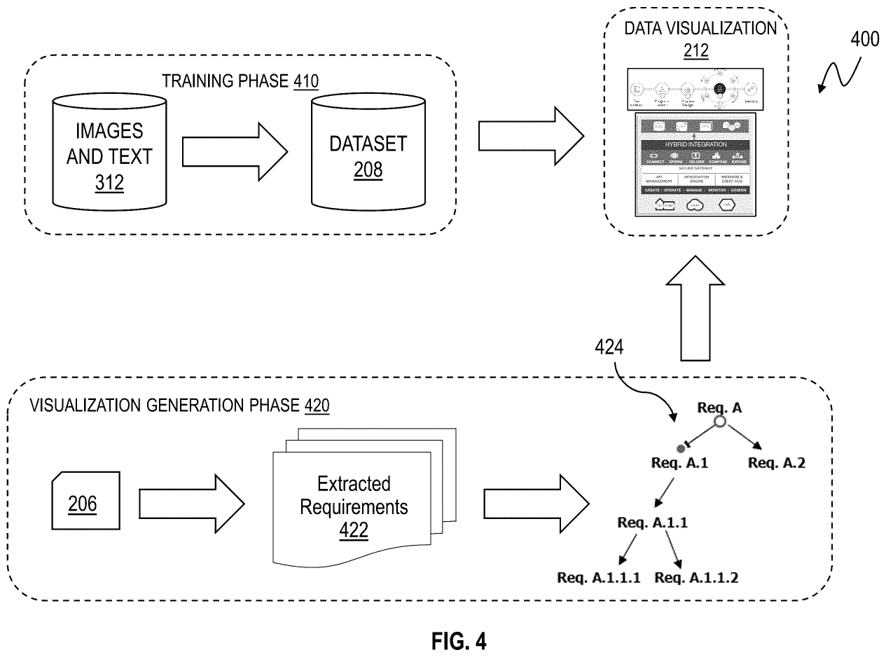

In some embodiments, the visualization generator 308 builds and trains the text-to-diagram learning model used to generate the diagrams corresponding to the extracted requirements. The visualization generator builds the dataset 208 used to train the text-to-diagram learning model using images and text obtained from different sources and stored in a datastore, such as the images and text datastore 312. The building and training of the text-to-diagram learning model is further discussed in relation to FIG. 4.

The visualization generator 308 receives or obtains the hierarchical structure from the enrichment module 306. The visualization generator 308 traverses through the hierarchical structure and analyzes each enriched node. The visualization generator 308 uses data from an enriched node to generate a diagram. In some embodiments, the visualization generator 308 uses the text-to-diagram learning model to generate the diagram corresponding to the enriched node. The visualization generator 308 generates a data visualization 212 using the diagrams corresponding to the enriched nodes of the hierarchical structure. In some embodiments, the data visualization 212 is an interactive graphic display that includes diagrams that correspond to each extracted requirement from the functional specification file 206. In some embodiments, the data visualization 212 includes features that enable the user 202 to display additional information about the requirements, such as definitions, examples, related requirements, and the like. The data visualization 212 can include features that enable the user 202 to request additional data for a requirement, submit changes or identify errors in the data visualization 212, or the like. In some embodiments, the data visualization 212 identifies and highlights conflicting information in the requirements or identify requirements that require additional information from the user 202.

Now referring to FIG. 4, a data flow diagram depicting a detailed workflow 400 of a functional specification visualization system 150 in accordance with one or more embodiments of the present invention is shown. In some embodiments, the generation of the data visualization 212 is done through two phases-the training phase 410 and the visualization generation phase 420. The training phase 410 and the visualization generation phase 420 can be asynchronously performed.

During the training phase 410, the functional specification visualization system 150 builds and trains a text-to-diagram learning model that is used to generate a data visualization 212 that contains diagrams corresponding to the different requirements extracted from a functional specification file 206. In some embodiments, the visualization generator 308 builds a dataset 208 of associations among images and texts of requirements from functional specification files 206. The datasets 208 also includes associations of the images and texts with a type of diagram to illustrate in the data visualization 212.

The visualization generator 308 facilitates collecting diagrams or images and their descriptions from different sources. Examples of the corresponding text descriptions can include captions, titles, or descriptions of the images. Sources where the images and text descriptions can be collected can include previously submitted functional specification files 206, a knowledge bank, technical documents, websites or repositories identified by a user 202 as related to a topic, or the like. In some embodiments, the visualization generator 308 directs the images and corresponding text descriptions be stored in the images and text datastore 312. In some embodiments, the visualization generator 308 manages a periodic collection of images and texts, such as monthly, or manages a continuous collection of images and texts as sources for collection are identified from incoming functional specification files 206 or other sources.

In some embodiments, the visualization generator 308 uses one more artificial intelligence techniques or learning models to apply to the images and text datastore 312 to generate associations between the images and text. The visualization generator 308 can preprocess the data and the images, which can include cleaning the data, standardizing the data, and breaking down the data in preparation for processing. For example, preprocessing text can include turning all text into lowercase, removing extra spaces or symbols, tokenizing the text into words or subwords, removing stop words, and applying stemming or lemmatization to the tokenized text to reduce words to their root form. Preprocessing images can include resizing the image, normalizing pixel values, cropping or centering the image, and converting the colors of the image to make sure they are in a common format.

The visualization generator 308 can process the preprocessed images and text by vectorizing and indexing them using one or more techniques for vectorization and indexing. The visualization generator 308 can then apply one or more AI techniques or learning methods, such as generative adversarial networks, to associate the images and their corresponding diagrams to a type of diagram suitable for illustration in the data visualization 212, such as a block diagram, a flow chart, a timeline, or the like. In some embodiments, the visualization generator 308 uses image segmentation to detect image components of images to use in associating associations between images, text, and the type of diagram. The visualization generator 308 maps the textual content with the graphical content withing the extracted images and diagrams and then associates the mapping with the type of diagram to associate with the text or image identified. The processed content of the images and text and their associated diagram types are then stored in the dataset 208.

The visualization generator 308 uses the dataset 208 to train the text-to-diagram learning model to be used to generate data visualizations 212 that correspond to functional specification files 206. In some embodiments, the visualization generator 308 trains an AI model to identify which types of diagrams are suitable for illustration in a data visualization 212 using the data curated and stored in the dataset 208.

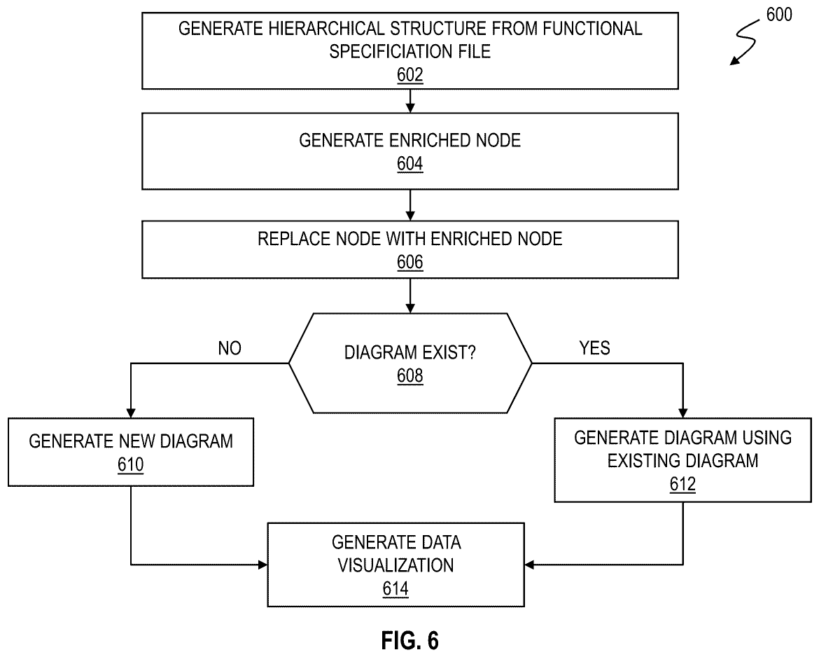

During the visualization generation phase 420, the functional specification visualization system 150 receives a functional specification file 206, generates extracted requirements 422 from the functional specification file 206, and builds a hierarchical structure 424 based on the extract requirements 422. The functional specification visualization system 150 then uses the text-to-diagram training model trained during the training phase 410 to generate the data visualization 212 using the hierarchical structure 424. Details about generating the extracted requirements 422 from the functional specification file 206 are further discussed in FIG. 5. Details about generating the data visualization 212 are further discussed in FIG. 6.

Referring now to FIG. 5, a flowchart of a method 500 for extracting requirements from a functional specification file 206 to generate data visualizations 212 in accordance with one or more embodiments of the present invention is shown. The method 500 begins at block 502 by processing a functional specification file 206. In some embodiments, the functional specification file 206 is received from a user device 204. The functional specification file 206 is processed by a requirements module 302 of the functional specification visualization system 150.

The requirements module 302 preprocesses the content of the functional specification file 206. Preprocessing the content can include cleaning the data, standardizing the data, and breaking down the data in preparation for processing. For example, preprocessing text can include turning all text into lowercase, removing extra spaces or symbols, tokenizing the text into words or subwords, removing stop words, and applying stemming or lemmatization to the tokenized text to reduce words to their root form. Similarly, preprocessing images can include resizing the image, normalizing pixel values, cropping or centering the image, and converting the colors of the image to make sure they are in a common format.

The requirements module 302 communicates with the AI engine 310 of the functional specification visualization system 150 to use one or more artificial intelligence techniques or models to process the functional specification file 206. Processing the functional specification file 206 can include vectorizing the contents of the functional specification file 206 using any known techniques of vectorization to transform the content into numerical representations, such as vectors or embeddings. Embeddings are vectors that represent data points in multi-dimensional space so that data that is close to each other represent similar items while items farther apart represent dissimilar items. Embeddings are vectors that represent data points in a multi-dimensional space. This space is designed so that points representing similar items are close to each other, while dissimilar items are farther apart. In some embodiments, the AI engine 310 extracts images or diagrams and context information associated with the image (e.g., captions, references in text, etc.) from the functional specification file 206, generates a text summary of the image and context information, and vectorizes and indexes the text summary. In some embodiments, the AI engine 310 segments the content of the functional specification file 206 before vectorizing and indexing it to generate processed content of the functional specification file 206.

Next at block 504, the requirements module 302 directs the AI engine 310 to use one or more AI techniques or models to analyze the file structure of the functional specification file 206 using the processed content from block 502. In some embodiments, the AI techniques or models examine the processed content of the functional specification file 206 to perform layout detection. Layout detection performed by one or more AI techniques or models can include examining font sizes and styles, whitespace patterns, indentations, and visual features of the processed content to determine where blocks of text, images, tables, or sections are on the page. Logical structure detection can be used to determine what each block represents, such as headings, body paragraphs, tables, images, captions, and the like. Text clues, such as bullets or numbered lists, can also be used to detect blocks in the functional specification file 206 in logical structure detection.

Next at block 506, the requirements module 302 directs the AI engine 310 to use one or more AI techniques or models to perform textual content extraction. Textual content extraction can include parsing and analyzing the processed content to detect characters, lines, and paragraphs and extracting only the text. In some embodiments, textual content extraction includes noise removal, data de-duplication, and layout preservation. The extracted text from the processed content can be used as the text displayed in the data visualization 212.

Next at block 508, the requirements module 302 directs the AI engine 310 to use one or more AI techniques or models to apply semantic analysis and requirements classification. In some embodiments, the AI engine 310 utilizes one or more known techniques for semantic analysis of the processed content of the functional specification file 206 to understand the relationship between the words and meanings of each identified block of the processed content of the functional specification file 206. In some embodiments, the requirements module 302 identifies a data taxonomy or data ontology to apply to the content of the functional specification file 206 based on the semantic analysis. The AI techniques or models can use a requirements dataset to perform the semantic analysis. The requirements dataset can include requirements extracted from previously submitted functional specification files 206, information obtained from users 202 specifying or associating taxonomies or ontologies with identified requirements, or the like.

Next at block 510, the requirements module 302 extracts requirements from the functional specification file 206. In some embodiments, the requirements module 302 generates a data structure that represents the extracted requirements 422. The data structure can include the extracted textual content from the functional specification file 206, metadata generated from the analysis of the file structure of the functional specification file 206 that indicates relationships between identified requirements, and classification of identified requirements from the semantic analysis of the processed content of the functional specification file 206. In some embodiments, the data structure is transmitted to the hierarchical structure module 304, further discussed in FIG. 6.

Referring now to FIG. 6, a flowchart of a method 600 for generating a data visualization 212 corresponding to a functional specification files 206 in accordance with one or more embodiments of the present invention is shown. The method 600 begins at block 602 by generating a hierarchical structure 424 from the functional specification file 206. The hierarchical structure module 304 receives the data structure generated by the requirements module 302 representing the extracted requirements 422 of the functional specification file 206, as discussed in FIG. 5. The hierarchical structure module 304 generate a hierarchical structure 424 using the data from the data structure. In some embodiments, the hierarchical structure module 304 generates a tree structure. Each node of the tree structure corresponds to an extracted requirement 422 from the functional specification file 206. The hierarchical structure module 304 uses the extracted textual content to generate nodes for each extracted requirement 422 and uses the metadata generated from the file structure analysis to configure the nodes to reflect the identified relationships between the extracted requirements 422.

Next at block 604, enriched nodes are generated. In some embodiments, the enrichment module 306 receives the hierarchical structure 424 from the hierarchical structure module 304. The enrichment module 306 traverses through the hierarchical structure 424 and directs the AI engine 310 to analyze the node based on its position in the hierarchical structure 424, the classification requirement of the node, and/or a data taxonomy associated with the hierarchical structure 424 to identify keywords of the textual content of the node. The AI engine 310 uses one or more AI techniques or models to obtain contextual information related to the keywords. In some embodiments, the AI engine 310 obtains the contextual information from the functional specification file 206, the context datastore 210, or another source of data.

The enrichment module 306 generates an enriched node using the data from the current node and the obtained contextual information. The enrichment module 306 augments or modifies the node of the hierarchical structure using the context information to generate the enriched node. In some embodiments, the enrichment module 306 generates the enriched node by creating a new node using information from the current node of the hierarchical structure 424 and the context information.

Next at block 606, the enrichment module 306 replaces the current node of the hierarchical structure 424 with the enriched node and deletes the node that was previously in the hierarchical structure 424. The enrichment module 306 repeats this process for each node of the hierarchical structure 424.

Next at block 608, a determination is made whether a diagram exists that corresponds to the enriched node of the hierarchical structure 424. The visualization generator 308 receives the hierarchical structure 424 from the enrichment module 306 and traverses through the hierarchical structure 424. The visualization generator 308 analyzes each enriched node. For example, the visualization generator 308 uses data from an enriched node to determine if a diagram corresponding to the content of the enriched node already exists. In some embodiments, the visualization generator 308 determines what type of diagram corresponds to the enriched node based on the classification of the requirement of the node, type of diagram identified by the requirements module 302, and the like. If the visualization generator 308 determines that a diagram corresponding to the enriched node does not exist, the method proceeds to block 610.

At block 610, a new diagram corresponding to the enriched node of the hierarchical structure 424 is generated and associated with the enriched node. In some embodiments, the visualization generator 308 uses the text-to-diagram learning model to generate the diagram corresponding to the enriched node. In some embodiments, the visualization generator 308 generates the diagram using the data of the enriched node, associates the diagram with the enriched node, and stores the diagram in the dataset 208.

If at block 608, the visualization generator 308 determines that a diagram corresponding to the enriched node of the hierarchical structure 424 exists, the method proceeds to block 612, where the visualization generator 308 generates a diagram by updating the existing diagram using data from the enriched node of the hierarchical structure 424 and associating the updated diagram with the enriched node.

At block 614, the visualization generator 308 generates a data visualization 212 using the diagrams corresponding to the enriched nodes of the hierarchical structure 424. The visualization generator 308 compiles the various diagrams generated that correspond to the enriched nodes of the hierarchical structure 424 into a data visualization 212. The data visualization 212 is an interactive graphic display that includes the generated diagrams that correspond to each extracted requirement 422 from the functional specification file 206. In some embodiments, the data visualization 212 includes features that enable the user 202 to display additional information about the requirements, such as definitions, examples, related requirements, and the like. The data visualization 212 can include features that enable the user 202 to request additional data for a requirement, submit changes or identify errors in the data visualization 212, or the like. In some embodiments, the data visualization 212 identifies and highlights conflicting information in the requirements or identify requirements that require additional information from the user 202. The visualization generator 308 transmits the data visualization 212 to the user device 204 or otherwise makes the data visualization 212 accessible by the user device 204.

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

One or more of the methods described herein can be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

In some embodiments, various functions or acts can take place at a given location and/or in connection with the operation of one or more apparatuses or systems. In some embodiments, a portion of a given function or act can be performed at a first device or location, and the remainder of the function or act can be performed at one or more additional devices or locations.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The present disclosure has been presented for purposes of illustration and description but is not intended to be exhaustive or limited to the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

The diagrams depicted herein are illustrative. There can be many variations to the diagram, or the steps (or operations) described therein without departing from the spirit of the disclosure. For instance, the actions can be performed in a differing order or actions can be added, deleted, or modified. Also, the term “coupled” describes having a signal path between two elements and does not imply a direct connection between the elements with no intervening elements/connections therebetween. All of these variations are considered a part of the present disclosure.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

1. A computer-implemented method comprising:
generating processed content of a functional specification file received from a user device by:
segmenting content of the functional specification file;
performing layout detection using font sizes and styles, whitespace patterns, indentations, and visual features to identify blocks of text, images, tables, or sections in the functional specification file; and
performing textual content extraction to extract textual content from the blocks while preserving layout information; and
generating a hierarchical structure using requirements extracted from the textual content extracted from the block, wherein each node of the hierarchical structure corresponds to a requirement extracted from the textual content extracted from the blocks;
generating an enriched node corresponding to a node of the hierarchical structure using the functional specification file and contextual data;
replacing the node of the hierarchical structure with the enriched node;
generating a diagram for the enriched node using a text-to-diagram learning model; and
generating a data visualization of the functional specification file comprising the diagram for the enriched node of the hierarchical structure.

2. The computer-implemented method of claim 1, wherein generating the enriched node using the functional specification file and the contextual data comprises:
analyzing the node of the hierarchical structure based on a position of the node in the hierarchical structure, a classification of the requirement of the node, and a data taxonomy associated with the hierarchical structure;
collecting the contextual data by obtaining data associated with the requirement of the node; and
generating the enriched node by augmenting the node with the contextual data.

3. The computer-implemented method of claim 1, wherein the contextual data is extracted from a related functional specification file, a related hierarchical structure, or a knowledge bank.

4. The computer-implemented method of claim 1, further comprising:
building a dataset comprising associations between images, textual descriptions, and types of diagram using generative adversarial networks, wherein the images and text descriptions are obtained from a data source; and
training the text-to-diagram learning model using the dataset and a deep learning model.

5. The computer-implemented method of claim 1, wherein generating the diagram for the enriched node using the text-to-diagram learning model further comprises:
determining whether the diagram for the enriched node exists; and
in response to determining that the diagram for the enriched node does exist, updating the diagram using the enriched node and associating the diagram with the enriched node.

6. The computer-implemented method of claim 1, wherein generating the diagram for the enriched node using the text-to-diagram learning model further comprises:
determining whether the diagram for the enriched node exists; and
in response to determining that the diagram for the enriched node does not exist,
generating a new diagram using the text-to-diagram learning model; and
associating the enriched node with the new diagram.

7. The computer-implemented method of claim 1, further comprising:
identifying the requirements of the functional specification file using file parsing, file structure analysis, textual content extraction, and semantic analysis of the processed content of the functional specification file; and
extracting the requirements from the textual content extracted from the blocks.

8. A system comprising:
a memory having computer readable instructions; and
one or more processors for executing the computer readable instructions, the computer readable instructions controlling the one or more processors to perform operations comprising:
generating processed content of a functional specification file received from a user device by:
segmenting content of the functional specification file;
performing layout detection using font sizes and styles, whitespace patterns, indentations, and visual features to identify blocks of text, images, tables, or sections in the functional specification file; and
performing textual content extraction to extract textual content from the blocks while preserving layout information; and
generating a hierarchical structure using requirements extracted from the textual content extracted from the block, wherein each node of the hierarchical structure corresponds to a requirement extracted from the textual content extracted from the blocks;
generating an enriched node corresponding to a node of the hierarchical structure using the functional specification file and contextual data;
replacing the node of the hierarchical structure with the enriched node;
generating a diagram for the enriched node using a text-to-diagram learning model; and
generating a data visualization of the functional specification file comprising the diagram for the enriched node of the hierarchical structure.

9. The system of claim 8, wherein the operations to generate the enriched node using the functional specification file and the contextual data further comprise:
analyzing the node of the hierarchical structure based on a position of the node in the hierarchical structure, a classification of the requirement of the node, and a data taxonomy associated with the hierarchical structure;
collecting the contextual data by obtaining data associated with the requirement of the node; and
generating the enriched node by augmenting the node with the contextual data.

10. The system of claim 8, wherein the contextual data is extracted from a related functional specification file, a related hierarchical structure, or a knowledge bank.

11. The system of claim 8, wherein the operations further comprise:
building a dataset comprising associations between images, textual descriptions, and types of diagram using generative adversarial networks, wherein the images and text descriptions are obtained from a data source; and
training the text-to-diagram learning model using the dataset and a deep learning model.

12. The system of claim 8, wherein the operations to generate the diagram for the enriched node using the text-to-diagram learning model further comprises:
determining whether the diagram for the enriched node exists; and
in response to determining that the diagram for the enriched node does exist, updating the diagram using the enriched node and associating the diagram with the enriched node.

13. The system of claim 8, wherein the operations to generate the diagram for the enriched node using the text-to-diagram learning model further comprises:
determining whether the diagram for the enriched node exists; and
in response to determining that the diagram for the enriched node does not exist,
generating a new diagram using the text-to-diagram learning model; and
associating the enriched node with the new diagram.

14. The system of claim 8, wherein the operations further comprise:
identifying the requirements of the functional specification file using file parsing, file structure analysis, textual content extraction, and semantic analysis of the processed content of the functional specification file; and
extracting the requirements from the textual content extracted from the blocks.

15. A computer program product comprising a computer readable storage medium having program instructions embodied therewith, the program instructions executable by a processor to cause the processor to perform operations comprising:
generating processed content of a functional specification file received from a user device by:
segmenting content of the functional specification file;
performing layout detection using font sizes and styles, whitespace patterns, indentations, and visual features to identify blocks of text, images, tables, or sections in the functional specification file; and
performing textual content extraction from the blocks while preserving layout information; and
generating a hierarchical structure using requirements extracted from the textual content extracted from the block, wherein each node of the hierarchical structure corresponds to a requirement extracted from the textual content extracted from the blocks;
generating an enriched node corresponding to a node of the hierarchical structure using the functional specification file and contextual data;
replacing the node of the hierarchical structure with the enriched node;
generating a diagram for the enriched node using a text-to-diagram learning model; and
generating a data visualization of the functional specification file comprising the diagram for the enriched node of the hierarchical structure.

16. The computer program product of claim 15, wherein the operations to generate the enriched node using the functional specification file and the contextual data further comprise:
analyzing the node of the hierarchical structure based on a position of the node in the hierarchical structure, a classification of the requirement of the node, and a data taxonomy associated with the hierarchical structure;
collecting the contextual data by obtaining data associated with the requirement of the node; and
generating the enriched node by augmenting the node with the contextual data.

17. The computer program product of claim 15, wherein the contextual data is extracted from a related functional specification file, a related hierarchical structure, or a knowledge bank.

18. The computer program product of claim 15, wherein the operations further comprise:
building a dataset comprising associations between images, textual descriptions, and types of diagrams using generative adversarial networks, wherein the images and text descriptions are obtained from a data source; and
training the text-to-diagram learning model using the dataset and a deep learning model.

19. The computer program product of claim 15, wherein the operations to generate the diagram for the enriched node using the text-to-diagram learning model further comprise:
determining whether the diagram for the enriched node exists; and
in response to determining that the diagram for the enriched node does exist, updating the diagram using the enriched node and associating the diagram with the enriched node.

20. The computer program product of claim 15, wherein the operations to generate the diagram for the enriched node using the text-to-diagram learning model further comprise:
determining whether the diagram for the enriched node exists; and
in response to determining that the diagram for the enriched node does not exist,
generating a new diagram using the text-to-diagram learning model; and
associating the enriched node with the new diagram.
